(19) United States
(12) Patent Application Publication
(10) Pub. No.: US 2022/0096880 A1
(43) Pub. Date: Mar. 31, 2022

(54) Air Filter Mask

(71) Applicant: Liberty Health Technologies, Inc., Santa Barbara, CA (US)

(72) Inventor: Chris Outwater, Carpinteria, CA (US)

(21) Appl. No.: 17/449,072

(22) Filed: Sep. 27, 2021

Related U.S. Application Data
(60) Provisional application No. 63/084,058, filed on Sep. 28, 2020.

(51) Int. Cl. A62B 23/02; A41D 13/11; A62B 18/10; A62B 18/02

(52) U.S. Cl. CPC A62B 23/025; A62B 18/025; A62B 18/10; A41D 13/1107

(57) ABSTRACT

A multi-chambered mask separately filters inhaled and exhaled air. When a person inhales, air is drawn and filtered through a core mask into a core chamber. The core mask covers the nose and mouth of a person's face and creates the core chamber between the core mask and the person's face. When a person exhales, exhaled air is expelled from the person's mouth through to an outer chamber using a mouthpiece connected by a channel to a hole in the core mask. An outer mask covers a portion of the core mask and creates an outer chamber between the outer mask and the core mask for filtering air exhaled by the person. The mouthpiece is positioned near the person's mouth by the core mask, gathers exhaled air from the person, and directs the exhaled air from the person's mouth through the channel to the outer chamber.

### INTRODUCTION

### Field of the Invention

The teachings herein relate to respirators, medical face coverings, and masks. More specifically, various embodiments relate to masks that limit the mixing of inhaled and exhaled air within the mask and separately filter inhaled and exhaled air using more than one filtering chamber.

### Description of the Prior Art

In light of various respiratory diseases, including COVID 19, the CDC has issued guidance for all people to wear masks and maintain social distancing under certain circumstances. In addition, many state and local governments have mandated wearing masks. Also, various companies such as restaurants and airlines have mandated wearing air filter masks.

Therefore, people who choose to follow the recommendations and adhere to the law will choose to wear face masks to protect themselves and others. There are over 50 million people in the United States with compromised pulmonary conditions. This ranges from asthma to chronic obstructive pulmonary disease (COPD) and pulmonary fibrosis. These people need to wear masks to protect themselves from respiratory illnesses of all sorts and they also need to inhale as much oxygen as possible with each breath.

The problem is that many mask wearers, after a short period of time wearing a properly fitted N95 style mask, feel as if they are suffocating and cannot get enough fresh air. This is because the mask wearer has to actively pull air through the mask's filter material into his or her nose and mouth. More importantly, the wearer's warm, exhaled air is momentarily trapped in front of the wearer's nose and mouth. Because this stale, exhaled air is trapped in the mask it becomes part of the first air that is being drawn into the mask before mixing with fresh air from the ambient air, thus lowering the amount of fresh air and oxygen that can be inhaled into the lungs.

As a result, additional apparatus and methods are needed to reduce the exhaled air trapped in a mask with each exhale and increase the amount of fresh air and oxygen brought into the mask with each inhale.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is an exemplary cutaway diagram of a mask that includes separate breathing chambers to reduce the mixing of inhaled and exhaled air, in accordance with various embodiments.

FIG. 2 is an exemplary cutaway diagram of a bi-valve mask that includes separate breathing chambers to reduce the mixing of inhaled and exhaled air, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Mouthpiece and Air Channel

As described above, many mask wearers, after a short period of time wearing a properly fitted N95 style mask, feel as if they are suffocating and cannot get enough fresh air. This is because the mask wearer has to actively pull air through the mask's filter material into his or her nose and mouth. More importantly, the wearer's warm, exhaled air is momentarily trapped in front of the wearer's nose and mouth. Because this stale, exhaled air is trapped in the mask it becomes part of the first air that is being drawn into the mask before mixing with fresh air from the ambient air, thus lowering the amount of fresh air and oxygen that can be inhaled into the lungs.

As a result, additional apparatus and methods are needed to reduce the exhaled air trapped in a mask with each exhale and increase the amount of fresh air and oxygen brought into the mask with each inhale.

The intent of various embodiments is to have the most amount of fresh air come into the mask through the filtering material and have the least amount of exhaled air mixing with the incoming fresh air. In various embodiments, this is achieved by separating the exhaled air from the mask's breathing chamber using a mouthpiece inside the mask.

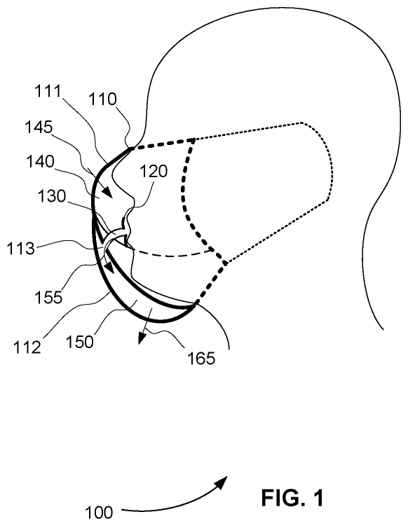

FIG. 1 is an exemplary cutaway diagram 100 of a mask that includes separate breathing chambers to reduce the mixing of inhaled and exhaled air, in accordance with various embodiments. Mask 110 includes interior mouthpiece 120, one or more air channel(s) 130, and one or more separate chamber(s) 150.

Interior mouthpiece 120 and air channel(s) 130 direct the exhaled air from the mask's breathing chamber 140 to a separate chamber(s) 150 so that exhaled air 155 does not mix with the incoming, fresh air 144 being pulled in from the ambient air outside mask 110. Exhaled air 155 is directed to at least one exhaled air chamber 150 that has enough volume so that there is very little or no resistance to the exhaled air released into mouthpiece 120.

Exhaled air 155 is filtered as it escapes from exhale chamber(s) 150 that are located down at the chin and/or running along the jawline. Therefore, this mask design and solution does not have an unfiltered exhale vent, which in many cases is unacceptable. To be clear, exhaled air 155 is filtered as it escapes or is pushed through exhaled air chambers' 150 outer filter layer, producing filtered exhaled air 165 that is released into the ambient air.

In one embodiment, exhaled air 155 is sent through mouthpiece 120 and channeled out and down to two, symmetrical chambers (not shown) running along the jawline. In another embodiment, exhaled air 155 is directed through mouthpiece 120 and is directed out and down towards the chin as shown.

In either embodiment, exhaled air 155 is forced through mouthpiece 120 and does not mix with fresh air 145 being drawn into the nose and/or mouth from the large upper section or chamber 140 of mask 110. It is important to note that the intention is to have as little air resistance as possible in either the inhalation or exhalation process. The intention is also to have as little stress as possible on the lungs as they inhale and exhale and to also make the inhaled air as fresh and oxygen-rich as possible.

Mouthpiece 120 can be made of coated paper or plastic. Mouthpiece 120 needs to be rigid enough to maintain its shape when it gets moist and/or is inadvertently bitten down on. Mouthpiece 120 must maintain its shape in order to allow sufficient airflow and low resistance to exhaled air 155 passing through mouthpiece 120 and entering the exhalation chamber(s) 150.

Mouthpiece 120 is mounted in the center of mask 110 and can be either shallow or deep. A shallow or short mouthpiece 120 would mean that the mask wearer would have to extend his or her lips to engage and seal their lips around mouthpiece 120 before exhaling. Deeper or longer mouthpiece 120 would enter the mouth area, perhaps one centimeter, like a straw, and would take less effort to engage. In other words, the mask wearer would not have to extend his or her lips to reach mouthpiece 120, but could simply close their lips around mouthpiece 120 before exhaling. In various alternative embodiments, mouthpiece 120 can also enter the mouth and be held by the teeth like a retainer or mouthguard.

Mouthpiece 120 and exhalation channel(s) 130 can be manufactured integral to mask 110 and mask 110 can be folded for shipping. When mask 110 is opened, the two halves of mouthpiece 120 could join together to offer a rigid structure. Mask 110 should only be slightly more expensive to manufacture than standard air filter masks on the market today.

Mask 110 generally favors inhaling through the nose, or both the nose and mouth, and exhaling exclusively through the mouth into mouthpiece 120. Mouthpiece 120, when sealed by the lips, acts as a separator, allowing exhaled air 155 to be channeled away and, in a preferred embodiment, down towards the chin and jawline. This allows only the fresh air 145 entering chamber 140 to be inhaled.

The inner layer of exhaled air chamber(s) 150 are air impermeable while the outer filter layer, or layers as the case may be, are air permeable and allow exhaled air 155 to pass out of chamber(s) 150 into the ambient air. To be clear, the inner layer is the layer closest to the wearer's face, the outer layer is the layer closest to the outside, ambient air.

Mouthpiece 120, channel(s) 130 and exhaled air chamber(s) 150 should be large enough to allow little or no resistance to the exhaled air from the mouth. Mouthpiece 120 could be various shapes, such as round, or oval, as long as exhaled air 155 can travel easily out to exhalation chamber(s) 150. As mentioned previously, exhalation chamber 150 could be a single chamber running down to the chin area or could be two symmetrical chambers running down along the jawline or a combination of chin plus jawline as shown.

In various embodiments, the area of mask 110 down by the chin and along the jawline is not used for fresh air 145 to be inhaled. The fresh air to be inhaled comes predominantly from the upper cheek and general cheek area of the mask, including the general nose and mouth area. For this reason, exhalation channel(s) 130 and chamber(s) 150 predominantly cover the lower chin and jawline. This offers the least restriction to drawing fresh ambient air 145 through the normal air filter material covering the cheeks, nose, and mouth area.

In various embodiments, exhalation mouthpiece tube or channel 130 has an optional one-way valve (not shown). This means that the wearer is required to release his lips from around mouthpiece 120 if inhaling, or the wearer could inhale only through the nose. The one-way valve also ensures that no exhaled air would enter back into fresh air breathing chamber 140.

If the mask wearer chooses the options of the longer, deeper mouthpiece 120 and the one-way exhale valve in mouthpiece 120, then the mask wearer would fall into a normal pattern of inhaling through the nose and exhaling through the mouth into mouthpiece 120. If the mask wearer falls asleep, for example, and his or her lips lose the seal around mouthpiece 120, then mask 110 would simply function as a normal air filter mask. Inhaled and exhaled air would be mixed and the wearer could breathe normally as if he or she were wearing a traditional mask.

In various embodiments, the use of mouthpiece 120 is optional and could be either never engaged or intermittently engaged. Mask 110 then functions essentially the same as any other filter mask if the mask wearer chooses not to use mouthpiece 120. There is no harm in not using mouthpiece 120. The benefit of using mouthpiece 120 is to separate exhaled air 155 from incoming fresh air 145 and make incoming, inhaled air 145 as fresh and full of oxygen as possible. Another benefit is to force exhaled, moist air 155 away from the eyes, especially if the mask wearer is also wearing goggles or glasses.

This unique mouthpiece 120 could also be used in more durable, rubber or plastic, full face masks, such as those manufactured by 3M and others. There could be an optional mouthpiece 120 that when used to direct exhaled air from the mouth, sends the exhaled air out of the breathing compartment into at least one air chamber 150 at the chin and/or along the jawline of the face and also far enough away from the air intake filter or filters so that exhaled air 155 is not mixed with incoming ambient air 145. As with the disposable mask, exhaled air 155 can escape out through the normal filter material, and this could be the same type of filter material, e.g. N95 material, used to filter incoming ambient air 145 from outside mask 110. This would comply with all policies regarding filtering exhaled air 155 from an air mask 110. Note that an “N95 mask” as used herein is a mask that includes filtering material that can filter 95 percent of aerosol particulates in accordance with guidelines from the U.S. National Institute for Occupational Safety and Health (NIOSH).

In another embodiment there is an impermeable seal (not shown) that runs in a line under the nose but above the mouth and running down each side of the mouth ending in the chin and jawline area where there are exhalation chambers. This embodiment allows the mask wearer to inhale through the nose and exhale through the mouth and does not require a mouthpiece. It does require a good seal line along the upper lip and down along the sides of the mouth in order to keep the exhaled air from the mouth mixing with the fresh air above the seal line. This embodiment with exhalation chambers can be referred to as the “chipmunk” mask.

U.S. patent application Ser. No. 16/589,550 (hereinafter the “'550 Application”) is directed to a respirator mask that provides for the exhaling of air during respiration therapy and prevents the backflow of exhaled air. The mask of the '550 Application includes a mouthpiece and tubing to direct the exhaled air to the exterior of the mask. The mask of the '550 Application does not include an additional chamber for capturing exhaled air and filtering it before releasing it to the exterior of the mask. In fact, the mask of the '550 Application does not teach or suggest filtering exhaled air in any manner.

### Mask for Separately Filtering Exhaled Air

Again in reference to FIG. 1, mask 110 is an exemplary mask for separately filtering exhaled air. Exemplary mask 110 includes core mask 111, outer mask 112, and mouthpiece 120 connected to channel 130.

Core mask 111 covers the nose and mouth of a person's face. Core mask 111 creates a core chamber 140 between core mask 111 and the person's face for filtering air drawn into core mask 111 when the person inhales.

Outer mask 112 covers a portion of core mask 111. Outer mask 112 creates an outer chamber 150 between outer mask 112 and core mask 111 for filtering air exhaled by the person.

Mouthpiece 130 is connected by channel 130 to a hole 113 in core mask 111 leading to outer chamber 150. Mouthpiece 130 is positioned near the person's mouth by core mask 111. Mouthpiece 130 gathers exhaled air from the person's mouth and directs it through channel 130 to outer chamber 150.

In various embodiments, mouthpiece 130 is positioned by core mask 111 to engage and make an airtight seal with the person's lips.

In various embodiments, mouthpiece 130 is positioned by core mask 111 to enter the person's mouth and allow the person to make an airtight seal with mouthpiece 130 when the person closes their mouth.

In various embodiments, the portion of core mask 111 forming a wall of outer chamber 150 is airtight, preventing exhaled air from returning to core chamber 140.

In various embodiments, the portion of core mask 111 covered by outer mask 111 is positioned to correspond to the lower chin and jawline of the person.

In various embodiments, hole 113, channel 130, or mouthpiece 120 further includes a one-way valve (not shown) to ensure that no exhaled air from outer chamber 150 is returned to core chamber 140. In various embodiments, the one-way valve is a check valve.

In various embodiments, mouthpiece 120 is made of a rigid material in order to maintain its shape. Mouthpiece 120 is, for example, made of plastic.

In various embodiments, the portion of core mask 111 not covered by outer mask 112 and the outer mask 112 are made from the same filter material that can filter at least 95 percent of aerosol particulates.

### Method for Separately Filtering Exhaled Air

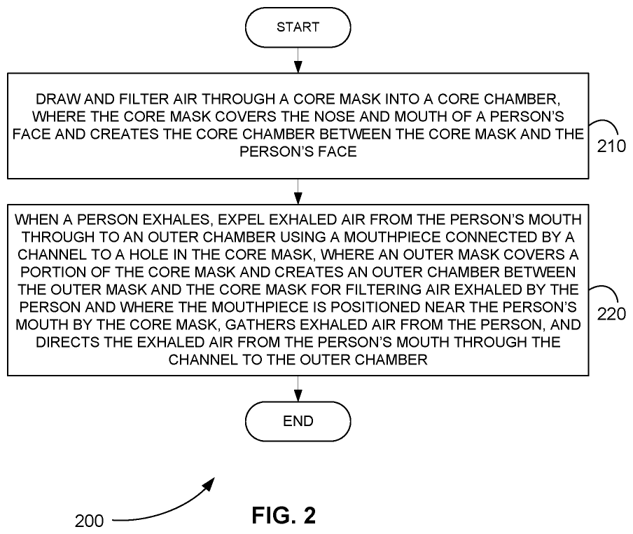

FIG. 2 is an exemplary flowchart showing a method 200 for separately filtering exhaled air using a mask, in accordance with various embodiments.

In step 210 of method 200, when a person inhales, air is drawn and filtered through a core mask into a core chamber. The core mask covers the nose and mouth of a person's face and creates the core chamber between the core mask and the person's face.

In step 220, when a person exhales, exhaled air is expelled from the person's mouth through to an outer chamber using a mouthpiece connected by a channel to a hole in the core mask. An outer mask covers a portion of the core mask and creates an outer chamber between the outer mask and the core mask for filtering air exhaled by the person. The mouthpiece is positioned near the person's mouth by the core mask, gathers exhaled air from the person, and directs the exhaled air from the person's mouth through the channel to the outer chamber.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A mask for separately filtering exhaled air, comprising:
a core mask for covering the nose and mouth of a person's face that creates a core chamber between the core mask and the person's face for filtering air drawn into the core mask when the person inhales;
an outer mask covering a portion of the core mask that creates an outer chamber between the outer mask and the core mask for filtering air exhaled by the person; and
a mouthpiece connected by a channel to a hole in the core mask leading to the outer chamber that is positioned near the person's mouth by the core mask and that gathers exhaled air from the person's mouth and directs it through the channel to the outer chamber.

2. The mask of claim 1, wherein the mouthpiece is positioned by the core mask to engage and make an airtight seal with the person's lips.

3. The mask of claim 1, wherein the mouthpiece is positioned by the core mask to enter the person's mouth and allow the person to make an airtight seal with the mouthpiece when the person closes their mouth.

4. The mask of claim 1, wherein the portion of the core mask forming a wall the outer chamber is airtight, preventing exhaled air from returning to the core chamber.

5. The mask of claim 1, wherein the portion of the core mask covered by the outer mask is positioned to correspond to the lower chin and jawline of the person.

6. The mask of claim 1, wherein the hole, the channel, or the mouthpiece further includes a one-way valve to ensure that no exhaled air from the outer chamber is returned to the core chamber.

7. The mask of claim 1, wherein the one-way valve comprises a check valve.

8. The mask of claim 1, wherein the mouthpiece is made of a rigid material in order to maintain its shape.

9. The mask of claim 8, wherein the mouthpiece is made of plastic.

10. The mask of claim 1, wherein the portion of the core mask not covered by the outer mask and the outer mask are made from the same filter material that can filter at least 95 percent of aerosol particulates.

11. A method for separately filtering exhaled air using a mask, comprising:
when a person inhales, drawing and filtering air through a core mask into a core chamber, wherein the core mask covers the nose and mouth of a person's face and creates the core chamber between the core mask and the person's face; and
when a person exhales, expelling exhaled air from the person's mouth through to an outer chamber using a mouthpiece connected by a channel to a hole in the core mask, wherein an outer mask covers a portion of the core mask and creates an outer chamber between the outer mask and the core mask for filtering air exhaled by the person and wherein the mouthpiece is positioned near the person's mouth by the core mask, gathers exhaled air from the person, and directs the exhaled air from the person's mouth through the channel to the outer chamber.

12. The method of claim 11, wherein the mouthpiece is positioned by the core mask to engage and make an airtight seal with the person's lips.

13. The method of claim 11, wherein the mouthpiece is positioned by the core mask to enter the person's mouth and allow the person to make an airtight seal with the mouthpiece when the person closes their mouth.

14. The method of claim 11, wherein the portion of the core mask forming a wall of the outer chamber is airtight, preventing exhaled air from returning to the core chamber.

15. The method of claim 11, wherein the portion of the core mask covered by the outer mask is positioned to correspond to the lower chin and jawline of the person.

16. The method of claim 11, wherein the hole, the channel, or the mouthpiece further includes a one-way valve to ensure that no exhaled air from the outer chamber is returned to the core chamber.

17. The method of claim 11, wherein the one-way valve comprises a check valve.

18. The method of claim 11, wherein the mouthpiece is made of a rigid material in order to maintain its shape.

19. The method of claim 18, wherein the mouthpiece is made of plastic

20. The method of claim 11, wherein the portion of the core mask not covered by the outer mask and the outer mask are made from the same filter material that can filter at least 95 percent of aerosol particulates.
